(19) United States
(12) Patent Application Publication
(10) Pub. No.: US 2014/0258179 A1
(43) Pub. Date: Sep. 11, 2014

(54) OPEN RETIREMENT ACCOUNT

(71) Applicant: BANK OF AMERICA CORPORATION, Charlotte, NC (US)

(72) Inventor: Matthew Bryant, Bellevue, KY (US)

(73) Assignee: BANK OF AMERICA CORPORATION, Charlotte, NC (US)

(21) Appl. No.: 13/794,044

(22) Filed: Mar. 11, 2013

(51) Int. Cl. G06Q 40/06

(52) U.S. Cl. CPC G06Q 40/06
USPC 705/36 T

(57) ABSTRACT

Methods, systems, and computer-readable media for providing an open retirement account are presented. An open retirement account may comprise of one or more financial accounts, for example, a checking account, a savings account, a 401k, an individual retirement account (IRA), a roth IRA, a certificate of deposit (CD), or any other suitable financial account. Deposits may be made to one or more of the financial accounts where the deposits may have one of a pre-tax state or a post-tax state. The tax states for the deposits may be tracked. The open retirement account may be displayed to a user such that the pre-tax balance is displayed separate from the post-tax balance. In some embodiments, a user may request to withdraw funds from a pre-tax portion of the open retirement account, and the system may compute a tax liability for the withdrawal. The tax liability, including any charges and/or a tax rate for the withdrawal, may be displayed to the user.

### BACKGROUND

Aspects of the disclosure relate to computer hardware and software. In particular, one or more aspects of the disclosure generally relate to computer hardware and software that can be used to provide an open retirement account to an account holder.

Individuals may have multiple financial accounts with multiple service providers. For example, an individual's employer may provide a 401k service offered by a first service provider and the individual may leverage a second service provider for an individual retirement account (IRA). In addition, if the individual moves to a new employer, a 401k provided by the new employer may be offered by a third service provider. Accordingly, extra effort is required to aggregate financial accounts in order to, for example, perform financial planning for the future.

Additionally, a number of financial accounts allow for deposits to be made with different tax states. Both a 401k and an IRA allow for pre-tax contributions and post-tax contributions (so-called “roth” accounts). This adds an additional layer of complexity when determining tax liability for future withdrawals. A need exists to reduce the burden placed on individuals that leverage these types of financial accounts.

### SUMMARY

Aspects of the disclosure provide various techniques that enable a mobile device to initiate and complete financial transactions, which may include making and receiving payments, in more secure, intuitive, convenient, and easy-to-use ways.

Methods, systems, and computer-readable media for providing an open retirement account are presented. An open retirement account may comprise of one or more subaccounts, for example, a checking account, a savings account, a 401k, a roth 401k, an individual retirement account (IRA), a roth IRA, a certificate of deposit (CD), or any other suitable financial account. Deposits may be made to one or more of the subaccounts where the deposits may have one of a pre-tax state or a post-tax state. Deposits may be made by an account holder, by an employer of an account holder, or by some other third-party.

In some embodiments, the tax states for the deposits may be tracked. The open retirement account may be displayed to a user such that the pre-tax balance is displayed separate from the post-tax balance. In some embodiments, a plurality of financial accounts for the open retirement account may include a pre-tax balance and the displayed pre-tax balance may be a sum of the pre-tax balances for the plurality of accounts. In other embodiments, the pre-tax balances for the plurality of subaccounts may be displayed separately.

In some embodiments, a user may request to withdraw funds from a pre-tax portion of the open retirement account, and the system may compute a tax liability for the withdrawal. The tax liability may be computed using stored tax rates. In some embodiments, the system may determine whether an early withdrawal charge should be assessed to the withdrawal. The computed tax liability may be displayed to a user. In some embodiments, an indication that indicates that an early withdrawal charge has been assessed to the withdrawal may be displayed to the user.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment according to an embodiment.

FIG. 1B illustrates another example operating environment according to an embodiment.

FIG. 2 illustrates an example process for adding an account to an open retirement account according to an embodiment.

FIG. 3 illustrates an example process for depositing into an open retirement account according to an embodiment;

FIG. 4-7 illustrate example webpages for depositing into an open retirement account according to an embodiment;

FIG. 8 illustrates an example process for displaying an open retirement account according to an embodiment;

FIGS. 9-12 illustrates example webpages for displaying an open retirement account according to an embodiment;

FIG. 13 illustrates an example process for computing tax liability according to an embodiment.

### DETAILED DESCRIPTION

In the following description of various embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

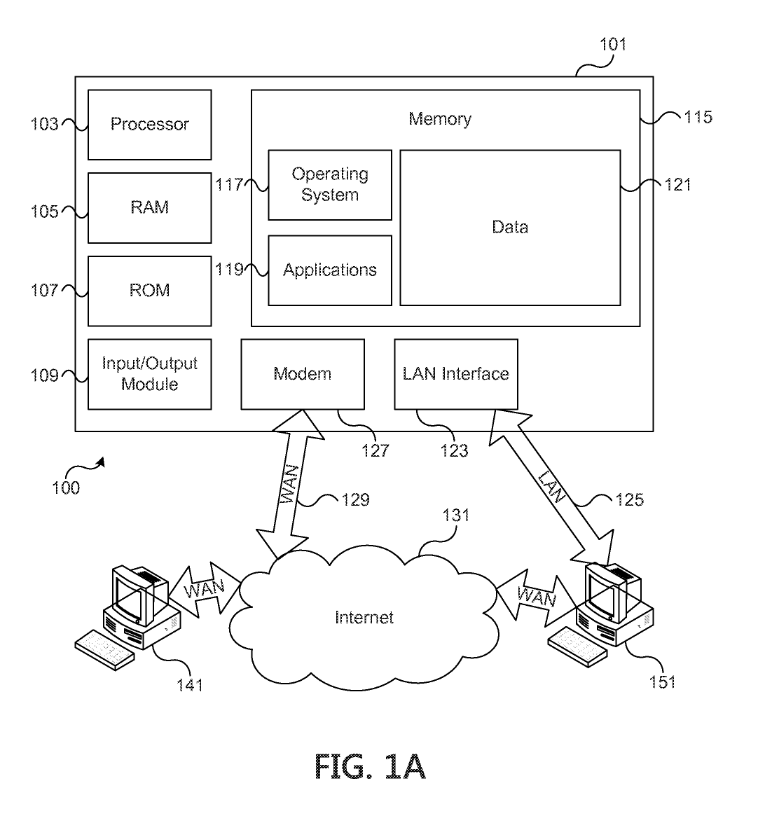

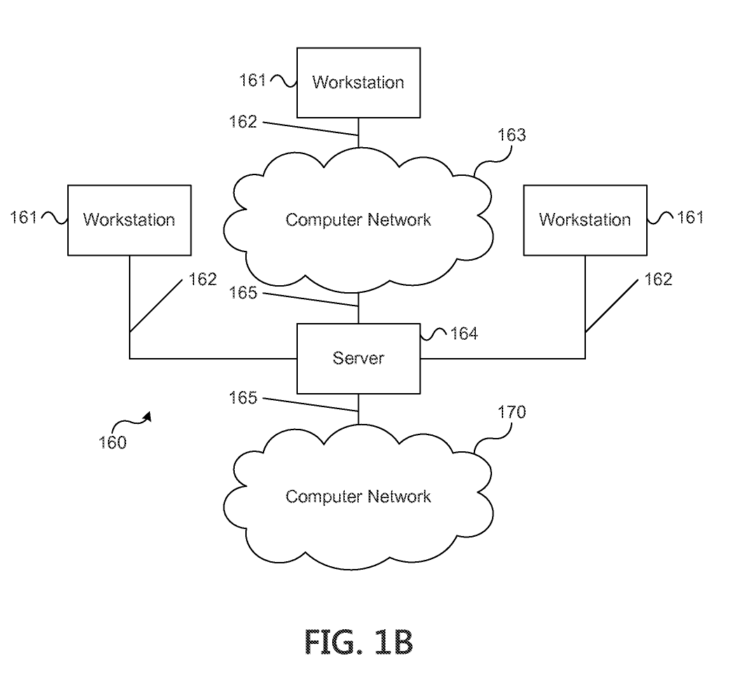

As noted above, certain illustrative embodiments are discussed herein that relate to an open retirement account where a plurality of sources may deposit into the account and a display of the balance for the account may include pre-tax and post-tax portions. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

In some embodiments, a service provider, for example a financial institution comprising a bank, may provide an open retirement account for an account holder. The account holder may be a person, a group of people, a corporation, a partnership, any other legal entity, or any entity suitable to hold a financial account. In some embodiments, an open retirement account comprises one or more financial accounts, for example, a checking account, a savings account, a 401k, a roth 401k, an individual retirement account (IRA), a roth IRA, a certificate of deposit (CD), or any other suitable financial account.

In some embodiments, one or more sources may deposit contributions, such as monetary contributions, into the open retirement account. The one or more sources may comprise the account holder, an employer of the account holder, any third-party person, or any third-party entity.

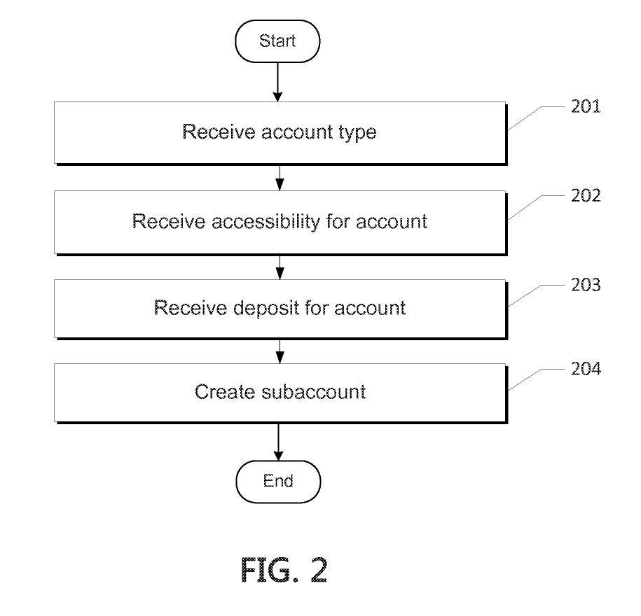

Examples processes for providing an open retirement account are described in FIGS. 2-10 with references to FIGS. 1A and 1B. FIG. 2 illustrates an example process for adding a subaccount to an open retirement account according to an embodiment. For example, a financial account, such as a 401k, may be added to an open retirement account. The process of FIG. 2 may start at step 201, where an account type is received. For example, the account type may be one of a checking account, a savings account, a 401k, an IRA, a roth IRA, a CD, or any other suitable financial account. The added financial account may be referred to herein as a subaccount of the open retirement account.

The process of FIG. 2 may proceed form step 201 to step 202, where an accessibility for a subaccount is received. An accessibility for a subaccount determines the source(s) that may deposit into the account. For example, an account holder and an employer for the account holder may deposit into a 401k account. Accordingly, an accessibility for a 401k account may define that only an account holder can contribute to the 401k or may define that the account holder and an employer for the account holder may contribute to the 401k. In another example, a contributor to a savings account may be an account holder, a third-party person, or any third-party entity. In some embodiments, step 202 may be omitted, for example, when an account type does not enable third-party contribution.

The process of FIG. 2 may proceed from step 202 to step 203 where a deposit is received for a subaccount. In some embodiments, an account may include a minimum balance, and a deposit may be required to create the subaccount. In other embodiments, a minimum balance is not required and step 203 may be omitted.

The process of FIG. 2 may move from step 203 to step 204 where a subaccount is created. For example, a 401k account may be created for an account holder of an open retirement account using the steps of FIG. 2. In some embodiments, once the 401k account is created, deposits, from either an account holder or an employer of the account holder, depending on the accessibility for the subaccount, may be made to the 401k account.

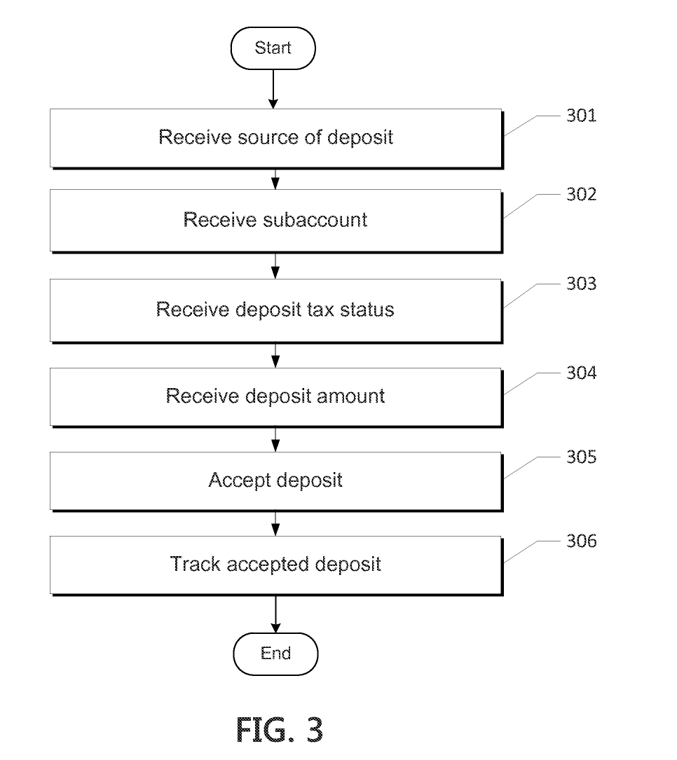

The process of FIG. 2 may be performed by a user, such as an account holder, interacting with a web page, a series of web pages, a web portal or a combination of these. The web page(s) and/or web portal may be hosted by, for example, a financial institution. The account holder may be using one of workstations 161 to interact with one or more web page(s) and/or a web portal that may be hosted by, for example, server 164. An example interaction between one or more web page(s) and/or a web portal and a user, such as an account holder or a third-party user, is further detailed below with reference to FIGS. 3-7. The process of FIG. 2 may be implemented using screen displays similar to those described with respect to the implementation described for the process of FIG. 3.

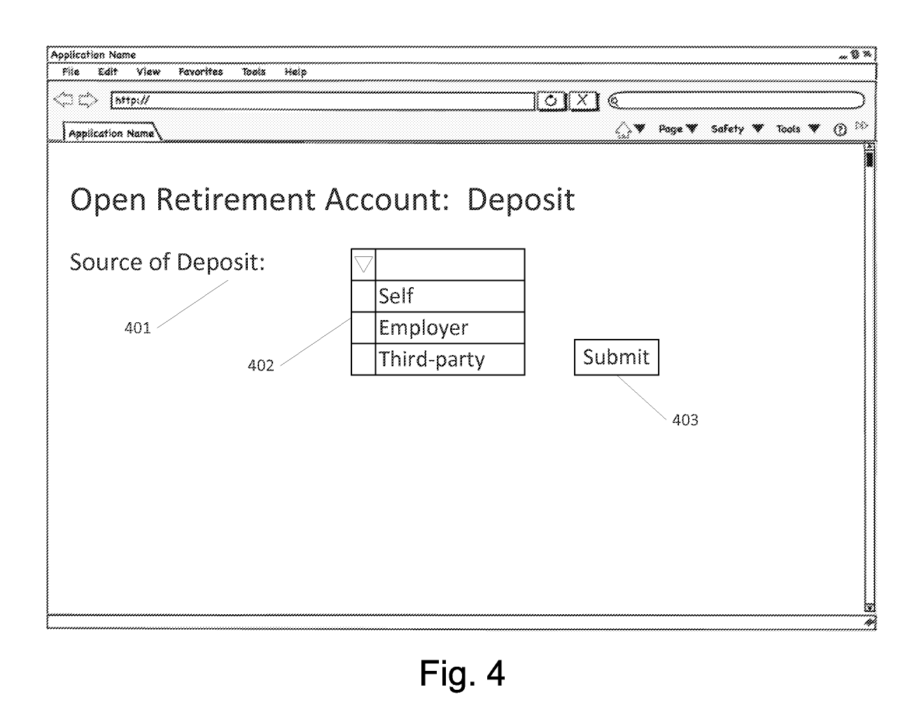

In some embodiments, one or more webpages such as that illustrated in FIG. 4 may be used to implement an embodiment. A webpage may leverage a number of web technologies in order to implement an embodiment, such as HTML, CSS, Java-script, AJAX, J2EE, .NET, and any other suitable technology. The webpage may include one or more forms, such as an input field, a text field, a drop down menu, a button, a slider, or any other suitable form. The webpage may further include an applet or some other type of web application to implement an embodiment.

FIG. 3 illustrates an example process for contributing to an open retirement account according to an embodiment. For example, one of an account holder or an employer of an account holder may make a deposit into a 401k account that has been added to an open retirement account. The process of FIG. 3 may be performed by a user, such as an account holder, interacting with a web page, a series of web pages, a web portal or a combination of these. The web page(s) and/or web portal may be hosted by, for example, a financial institution. The account holder may be using one of workstations 161 to interact with one or more web page(s) and/or a web portal that may be hosted by, for example, server 164.

The process of FIG. 3 may start at step 301 where a source for a deposit is received. A source may be the entity that is making the deposit. For example, for a 401k account, a source may be the account holder or an employer for the account holder. In another example, a source for a savings account may be any of an account holder, a third-party person, or any third-party entity. In some embodiments, a webpage such as that illustrated in FIG. 4 may be used to input a source for the deposit. Label 401 displays the function for drop down menu 402, in this case selecting a source for a deposit. Drop down menu 402 may be used to select the source. Once a source is selected, submit button 403 may be used to submit the source.

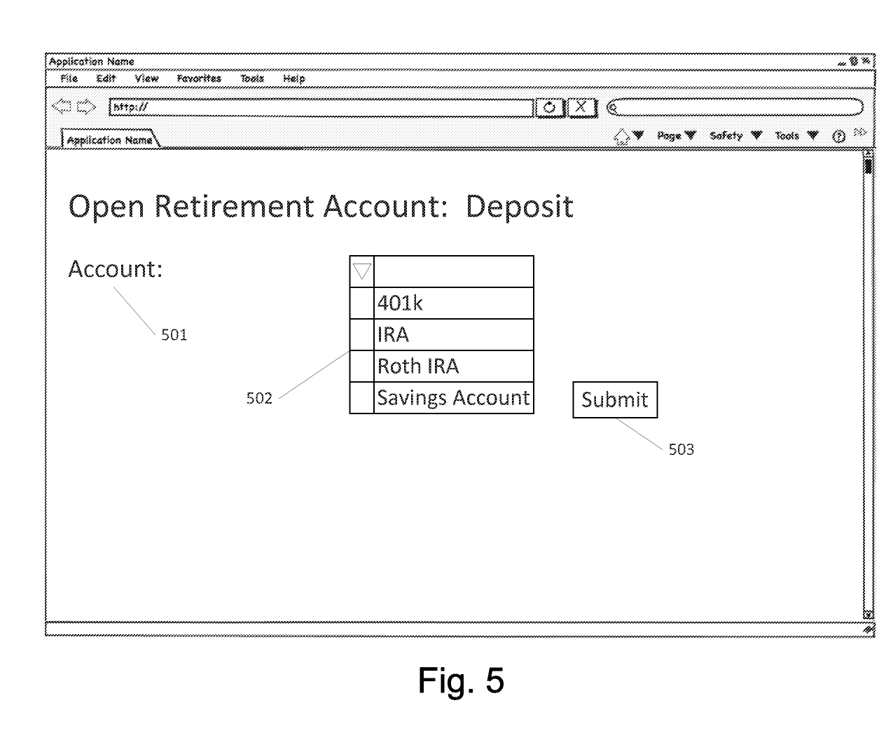

The process of FIG. 3 may proceed from step 301 to step 302 where a subaccount is received for the deposit. For example, a subaccount may be one of a checking account, a savings account, a 401k, an IRA, a roth IRA, a CD, or any other suitable financial account. In some embodiments, a webpage such as that illustrated in FIG. 5 may be used to input a subaccount for the deposit. Label 501 displays the function for drop down menu 502, in this case selecting an account for a deposit. Drop down menu 502 may be used to select the subaccount. In some embodiments, the web page depicted in FIG. 5 is a portion of a web portal that stores subaccount information for an account holder. Drop down menu 502 maybe populated with the subaccounts for an account holder based on the stored subaccount information. Once a subaccount is selected from drop down menu 502, submit button 503 may be used to submit the subaccount.

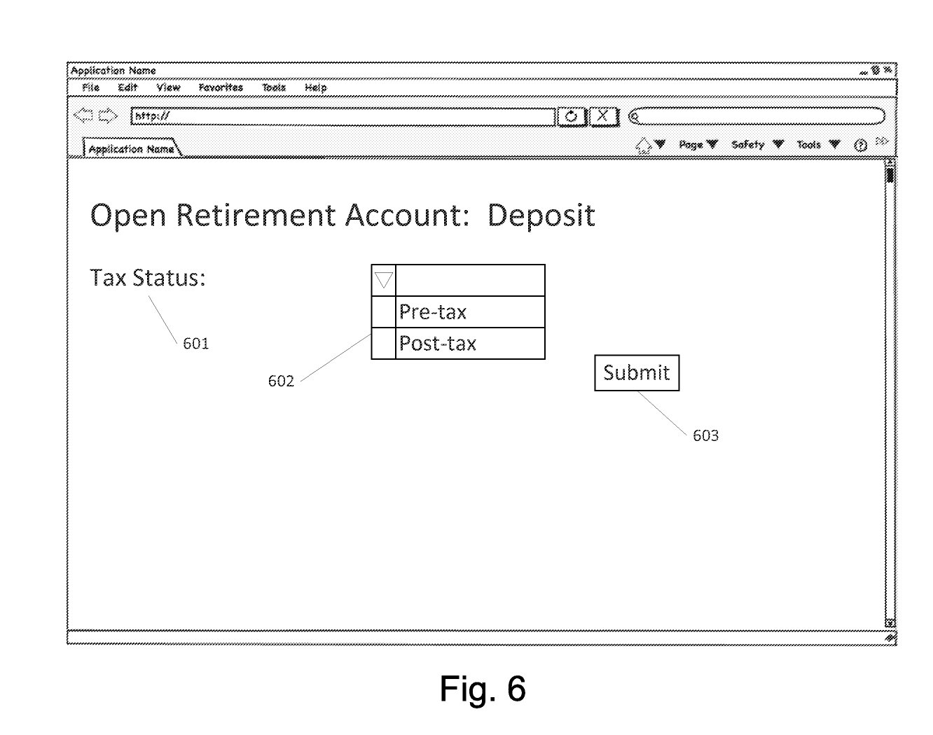

The process of FIG. 3 may proceed from step 302 to step 303 where a tax status is received for the deposit. For example, for a deposit into a 401k account, a tax status may be either pre-tax or post-tax. In some embodiments, a webpage such as that illustrated in FIG. 6 may be used to input a tax status for the deposit. Label 601 displays the function for drop down menu 602, in this case selecting a tax status for a deposit. Drop down menu 602 may be used to select the tax status. Once a tax status is selected, submit button 603 may be used to submit the tax status. In some embodiments, step 303 is omitted, for example, if an account is limited to deposits of only one tax status, such as a savings account limited to post-tax deposits.

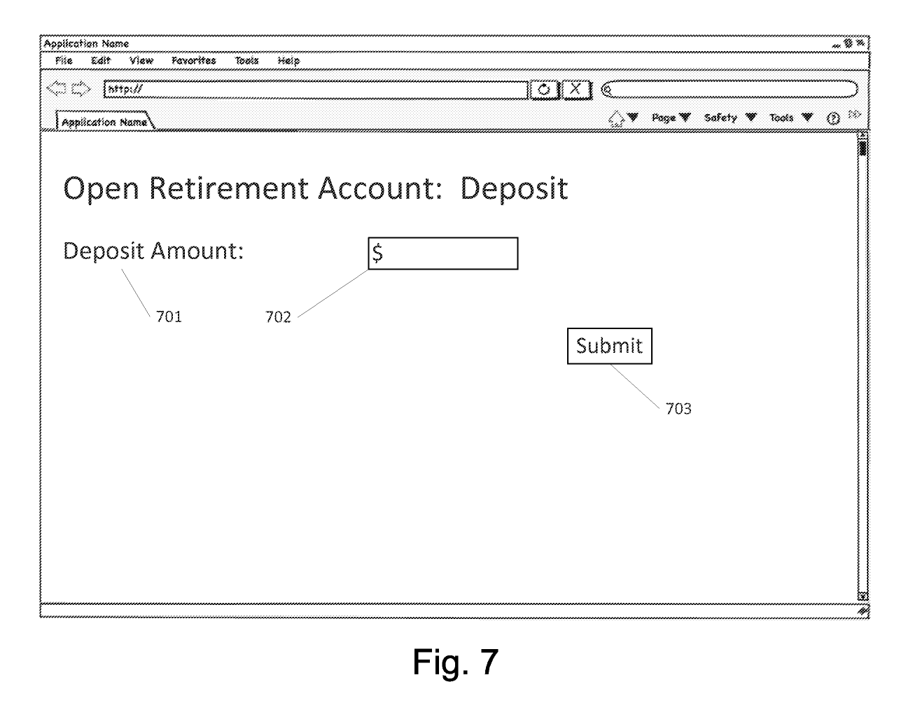

The process of FIG. 3 may proceed from step 303 to step 304 where an amount is received for the deposit. In some embodiments, a webpage such as that illustrated in FIG. 7 may be used to input the deposit amount. Label 701 displays the function for text input form 702, in this case accepting an amount for a deposit. Once a deposit amount is input into text input form 702, submit button 703 may be used to submit the amount.

The process of FIG. 3 may proceed from step 304 to step 305 where the deposit is accepted. In some embodiments, a deposit may be verified before it is accepted. For example, a received source that indicates the depositor is an employer of the account holder may include a verification step to ensure the depositor is actually an employer for the account holder. This verification may include contacting the account holder to verify the source. In some embodiments, an accessibility for a received subaccount is checked to verify that a received source has access to deposit into the received subaccount.

The process of FIG. 3 may proceed from step 305 to step 306 where the accepted deposit is tracked. In some embodiments, deposits to a particular subaccount may be tracked based on a tax status for the deposit. For example, pre-tax deposits to a 401k may be tracked. The deposit amount may be stored in association with the subaccount for the deposit and a tax status for the deposit. Accordingly, each deposit made to a subaccount, for example a 401k, may be identified as either pre-tax or post-tax deposit based on the tracking

In some embodiments, one or more of the webpages illustrated in FIGS. 3-7 may be combined. In another embodiment, the webpage illustrated in FIGS. 3-7 may comprise a portion of a web portal. Accordingly a user, such as an account holder or an employer of an account holder, may login to a web portal. The web portal may save information about the user, such as the source information received in step 301. In some embodiments, one or more of the steps described in the process of FIG. 3 may be omitted.

In some embodiments, the process of FIG. 3 may be used to initialize a reoccurring deposit. For example, the process of FIG. 3 may be used to initialize a deposit from an employer of the account holder into a 401k account. In this embodiment, further deposits based on the initialized reoccurring deposit may perform only a portion of the process of FIG. 3. For example, a reoccurring deposit to a 401k account from an account holder's employer may only implement steps 303 and 304. In another example, a reoccurring pre-tax deposit to a 401k account from an account holder's employer may only implement step 304.

While an exemplary embodiment for implementing the process of FIG. 3 through one or more web pages is described, the process may also leverage a local application. For example, a wireless device may include a mobile application that may be used to accomplish the process of FIG. 3. The webpages illustrated in FIGS. 4-7 may be replaced by one or more screens for the mobile application.

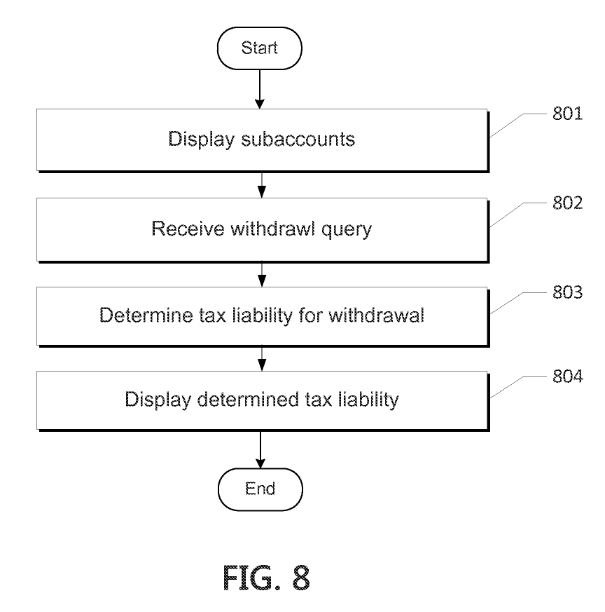

FIG. 8 illustrates an example process for displaying information about an open retirement account according to an embodiment. For example, a user, such as an account holder, may request that information about an open retirement account, such as information about one or more subaccounts included in the open retirement account, be displayed. The process of FIG. 8 may be performed by a user, such as an account holder, interacting with a web page, a series of web pages, a web portal or a combination of these. The web page(s) and/or web portal may be hosted by, for example, a financial institution. The account holder may be using one of workstations 161 to interact with one or more web page(s) and/or a web portal that may be hosted by, for example, server 164.

The process of FIG. 8 may start at step 801 where one or more subaccounts included in an open retirement account are displayed. For example, an open retirement account may include one or more of a checking account, a savings account, a 401k, a roth 401k, an IRA, a roth IRA, a CD, or any other suitable financial account. A balance for each subaccount included in the open retirement account may be displayed at step 801. In some embodiments, deposits may be tracked for each subaccount such that a tax status may be stored for the deposits. A balance for a subaccount may be displayed as a pre-tax balance and as a post-tax balance based on the stored tax status for the account deposits.

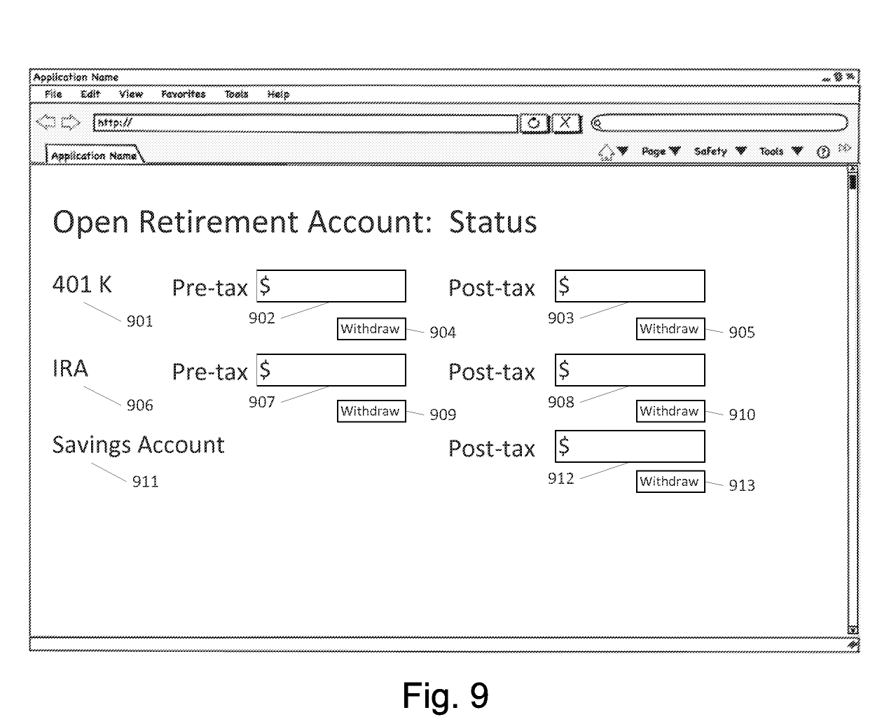

In some embodiments, a webpage such as that illustrated in FIG. 9 may be used to implement step 801. Label 901 indicates that text fields 902 and 903 display subaccount information for a 401k account included in an open retirement account. Text field 902 displays a pre-tax balance and the text field 903 displays a post-tax balance for the 401k account. Label 906 indicates that text fields 907 and 908 display subaccount information for an IRA account included in an open retirement account. Text field 907 displays a pre-tax balance and the text field 908 displays a post-tax balance for the IRA account. Label 911 indicates that text field 912 displays subaccount information for a savings account included in an open retirement account. Text field 912 displays a post-tax balance for the savings account. The savings account need not include a pre-tax balance because a savings account may not include pre-tax deposits.

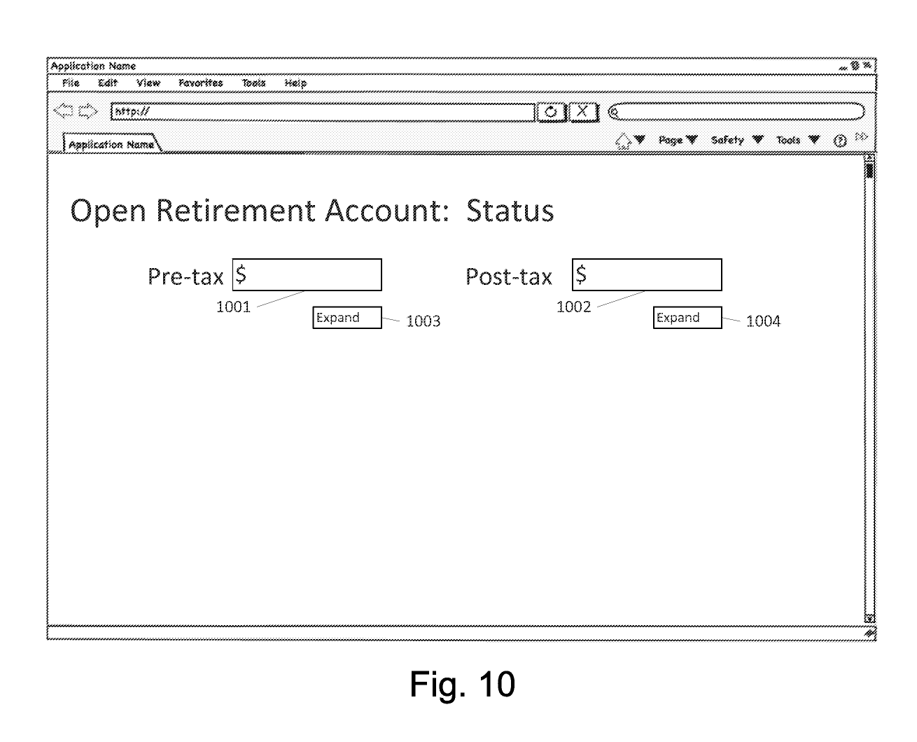

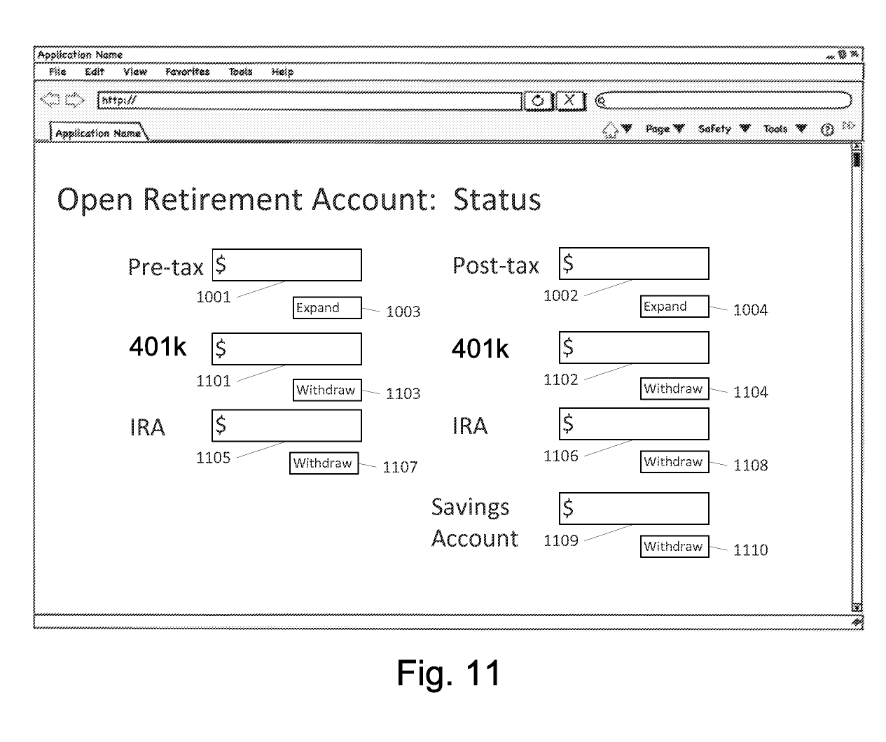

In some embodiments, webpages such as those illustrated in FIGS. 10 and 11 may be used to implement step 801. Text field 1001 may display a pre-tax balance for an open retirement account and text field 1002 may display a post-tax balance for the open retirement account. In some embodiments, the open retirement account may comprise a plurality of subaccounts. The pre-tax balance displayed in text field 1001 may comprise a sum of the pre-tax balance for each of the subaccounts included in the open retirement account. The post-tax balance displayed in text field 1002 may comprise a sum of the post-tax balance for each of the subaccounts included in the open retirement account. In some embodiments, expand button 1003 may expand the pre-tax display to show the separate pre-tax balances for each subaccount in the open retirement account and expand button 1004 may expand the post-tax display to show the separate post-tax balances for each subaccount in the open retirement account.

For example, a webpage such as that illustrated in FIG. 11 may display the expanded pre-tax and post-tax portions for the subaccounts included in the open retirement account. Text field 1101 may display a pre-tax balance for a 401k account, text field 1102 may display a post-tax balance for a 401k account, text field 1105 may display a pre-tax balance for an IRA account, text field 1106 may display a post-tax balance for an IRA account, and text field 1109 may display a post-tax balance of a savings account. The savings account need not include a pre-tax balance because a savings account may not include pre-tax deposits.

The process of FIG. 8 may proceed from step 801 to step 802 where a withdrawal query is received for a subaccount. For example, withdraw buttons 904, 905, 907, 908, and 912 may be used to withdraw funds from a pre-tax portion of a 401k account, a post-tax portion of a 401k account, a pre-tax portion of an IRA account, a post-tax potion of an IRA account, and a post-tax portion of a savings account respectively. Withdraw buttons 1103, 1104, 1107, 1108, and 1110 may operate similar to withdraw buttons 904, 905, 907, 908, and 912. A withdrawal query may be received when a withdraw button is clicked. The withdrawal query may include a subaccount and may further include a tax status (e.g., pre-tax or post-tax) for the subaccount. For example, a withdrawal query received based on withdraw button 904 may include a 401k account and a pre-tax status.

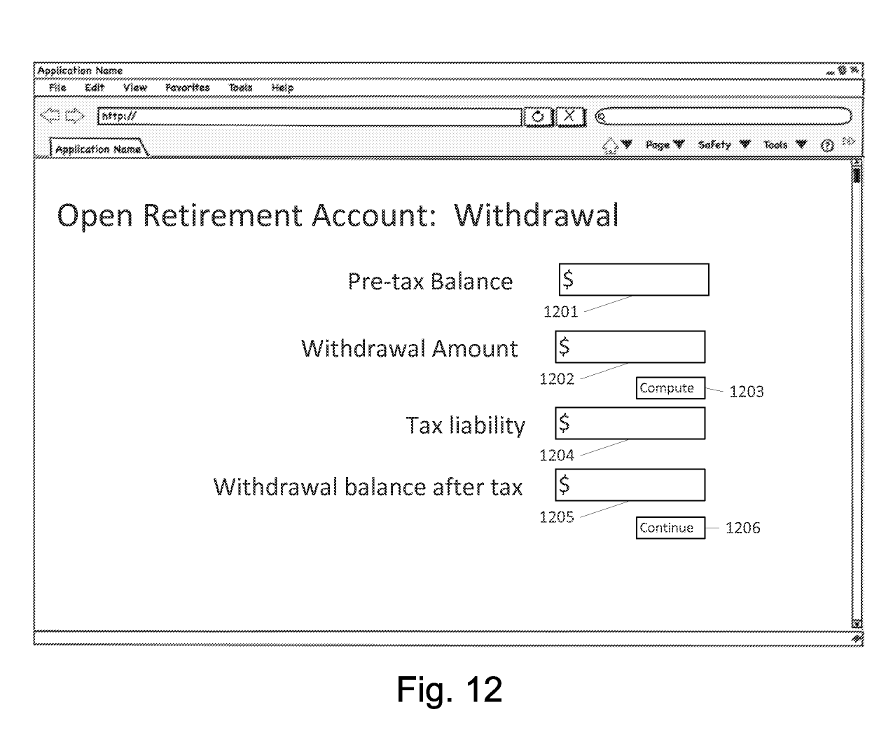

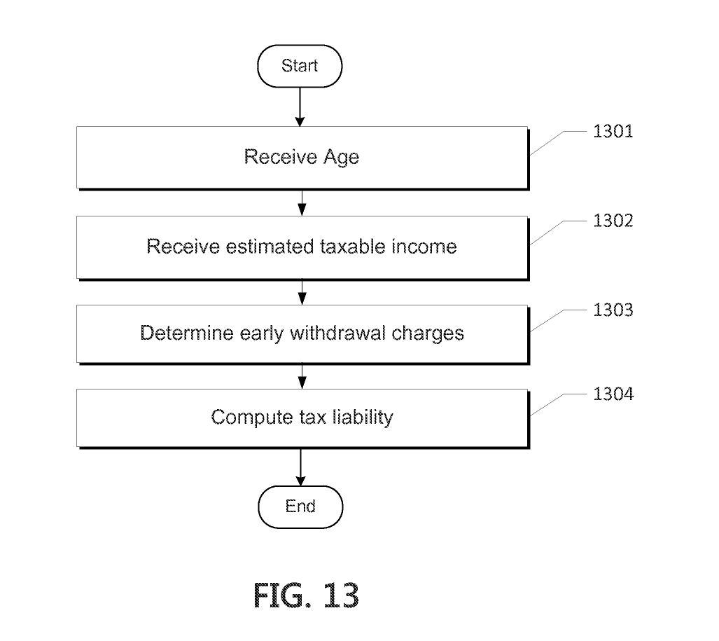

The process of FIG. 8 may proceed from step 802 to step 803 where a tax liability for a withdrawal is computed. In some embodiments, when a user clicks a withdraw button the user may be guided to a webpage such as that illustrated in FIG. 12. For example, when a user clicks withdraw button 904, a webpage as illustrated in FIG. 12 may be loaded, where the webpage is designated to perform a withdrawal from a pre-tax portion of a 401k account. Text field 1201 may display a pre-tax balance for the 401k account. Input text field 1202 may receive a withdrawal amount from a user. Once the withdrawal amount is entered, compute button 1203 may be used to compute a tax liability based on the withdrawal amount. An embodiment for calculating tax liability will be further described with reference to the process of FIG. 13. The tax liability may be computed and displayed in text field 1204. The tax liability may be subtracted from the withdrawal amount and the withdrawal balance after tax may be displayed in text field 1205. A user may continue with the withdrawal by clicking continue button 1206. Once the user continues with the withdrawal, the withdrawal may be completed.

FIG. 13 illustrates an example process for computing tax liability for an open retirement account according to an embodiment. For example, step 803 of FIG. 8 may further comprise the process of FIG. 13. The process of FIG. 13 may be performed by a user, such as an account holder, interacting with a web page, a series of web pages, a web portal or a combination of these. The web page(s) and/or web portal may be hosted by, for example, a financial institution. The user may be using one of workstations 161 to interact with one or more web page(s) and/or a web portal that may be hosted by, for example, server 164. An example interaction between one or more web page(s) and/or a web portal and a user, such as an account holder or a third-party user, is further detailed below with reference to FIGS. 3-7. The process of FIG. 13 may be performed similar to the process of FIG. 3.

The process of FIG. 13 may start at step 1301, where an age is received for a user. The process may proceed from step 1301 to step 1302, where an estimated taxable income is received from a user. For example, the received estimated taxable income may be based on the taxable income for the account holder during the previous tax year or some other estimate for taxable income. The received taxable income may be for a given taxable year. The process of FIG. 13 may proceed from step 1302 to step 1303, where early withdrawal charges are determined. For example, retirement accounts, such as a 401k or an IRA, may include early withdrawal charges based on a number of factors. Rules regarding early withdrawal charges may be stored. The rules may be stored such that particular rules are associated with a particular type of account (e.g., IRA, 401k). A charge, such as a 10% tax charge, may be assessed to an account holder that is below the predetermined age required for charge free withdrawal. Accordingly, the received age may be compared to a predetermined age to determine whether an early withdrawal charge should be assessed. In a further embodiment, a number of exceptions to the early withdrawal charge exist based on a number of factors. Rules regarding exceptions to early withdrawal charges may be stored. The rules may be stored such that particular rules are associated with exceptions to a particular type of subaccount (e.g., IRA, 401k). If it is determined that an account holder should be assessed an early withdrawal charge, one or more questions may be displayed to the user (e.g., account holder). One or more answers may be received from the user. The one or more answers may be compared to the stored exceptions and it may be determined whether an exception applies. If the account holder is eligible for an exception, the early withdrawal charge may not be assessed.

The process of FIG. 13 may proceed from step 1303 to step 1304, where a tax liability is computed. For example, the computed tax liability may be based on the received estimated taxable income for an account holder for a given taxable year. Tax rates may be stored for a given taxable year and a tax liability may be computed based on a comparison between the estimated taxable income for an account holder and the stored tax rates. The tax liability may further be based on whether an early withdrawal charge, such as a 10% tax charge, should be assessed. In some embodiments, an indicator may be displayed adjacent to a display of the tax liability if an early withdrawal charge is assessed. The tax liability may be computed and may further be displayed to an account holder, for example, in text form 1204 of FIG. 12. In some embodiments, a tax rate for the withdrawal may additionally be displayed adjacent to the tax liability.

In some embodiments, one or more of the webpages illustrated in FIGS. 9-12 may be combined. In another embodiment, the webpage illustrated in FIGS. 9-12 may comprise a portion of a web portal. Accordingly a user, such as an account holder or an employer of an account holder, may login to a web portal. The web portal may save information about the user, such as the age received in step 1301. In some embodiments, one or more of the steps described in the processes of FIGS. 8 and 13 may be omitted.

While an illustrative embodiment for implementing the processes of FIGS. 8 and 13 through one or more web pages is described, the process may also leverage a local application. For example, a wireless device may include a mobile application that may be used to accomplish the processes of FIGS. 8 and 13. The webpages illustrated in FIGS. 9-12 may be replaced by one or more screens for the mobile application.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computer implemented method, comprising:
receiving a first deposit for a financial account, wherein the first deposit comprises a pre-tax deposit;
tracking the first deposit as a pre-tax deposit;
receiving a second deposit for the financial account, wherein the second deposit comprises a post-tax deposit;
tracking the second deposit as a post-tax deposit;
displaying, to a user, a first portion of the financial account that comprises one or more pre-tax tracked deposits along with an indication that the first portion comprises a pre-tax balance for the financial account and a second portion of the financial account that comprises one or more post-tax tracked deposits along with an indication that the second portion comprises a post-tax balance of the financial account;
receiving a request to withdraw funds from a pre-tax portion of the financial account;
computing a tax liability for the pre-tax portion requested for withdrawal;
displaying, to the user, the computed tax liability for the withdrawal.

2. A method of claim 1, wherein computing a tax liability for the pre-tax portion further comprises determining whether to assess an early withdrawal charge.

3. A method of claim 2, wherein determining whether to assess an early withdrawal charge further comprises:
storing age restriction rules about pre-tax withdrawals;
receiving an age for an account holder;
comparing the received age to the stored age restrictions rules.

4. A method of claim 2, further comprising: if it is determined that an early withdrawal charge is to be assessed,
storing exceptions rules about exceptions to early withdrawal charges;
displaying one or more questions to the user related to the stored exception rules;
receiving answers to the one or more questions;
comparing the received answers to the stored exception rules;
determining whether an exception applies.

5. A method of claim 2, wherein displaying the computed tax liability further comprises displaying one or more of a tax rate for the withdrawal and an indication that indicates an early withdrawal charge has been assessed to the withdrawal.

6. A method of claim 1, wherein computing a tax liability for the pre-tax portion requested for withdrawal further comprises:
receiving, from the user, an estimated taxable income for a taxable year;
comparing the estimated taxable income to stored tax rates for the taxable year.

7. A method of claim 1, wherein a traditional account may be one of a 401k, an individual retirement account, a savings account, a checking account, or a certificate of deposit and wherein the financial account comprises at least two subaccounts that comprise traditional accounts.

8. A method of claim 7, wherein the at least two traditional accounts are different types of accounts.

9. A method of claim 1,
wherein the financial account comprises a least two subaccounts where each subaccount has a pre-tax balance, and
wherein displaying a first portion of the financial account that comprises one or more pre-tax tracked deposits along with an indication that the first portion comprises a pre-tax balance for the financial account further comprises displaying a sum of a pre-tax balance for the at least two accounts.

10. A method as of claim 1,
wherein the financial account comprises a least two subaccounts where each subaccount has a pre-tax balance, and
wherein displaying a first portion of the financial account that comprises one or more pre-tax tracked deposits along with an indication that the first portion comprises a pre-tax balance for the financial account further comprises displaying a pre-tax balance for a first of the at least two subaccounts separate from displaying a pre-tax balance for a second of the at least two subaccounts.

11. A system comprising:
a first computing device, with a processor, configured to:
receive a first deposit for a financial account, wherein the first deposit comprises a pre-tax deposit;
track the first deposit as a pre-tax deposit;
receive a second deposit for the financial account, wherein the second deposit comprises a post-tax deposit;
track the second deposit as a post-tax deposit;
display, to a user, a first portion of the financial account that comprises one or more pre-tax tracked deposits along with an indication that the first portion comprises a pre-tax balance for the financial account and a second portion of the financial account that comprises one or more post-tax tracked deposits along with an indication that the second portion comprises a post-tax balance of the financial account;
receive a request to withdraw funds from a pre-tax portion of the financial account;
compute a tax liability for the pre-tax portion requested for withdrawal;
display, to the user, the computed tax liability for the withdrawal.

12. A system of claim 11, wherein computing a tax liability for the pre-tax portion further comprises determining whether to assess an early withdrawal charge.

13. A system of claim 12, wherein determining whether to assess an early withdrawal charge further comprises:
storing age restriction rules about pre-tax withdrawals;
receiving an age for an account holder;
comparing the received age to the stored age restrictions rules.

14. A system of claim 12, wherein the first computing device is further configured to: if it is determined that an early withdrawal charge is to be assessed,
store exceptions rules about exceptions to early withdrawal charges;
display one or more questions to the user related to the stored exception rules;
receive answers to the one or more questions;
compare the received answers to the stored exception rules;
determine whether an exception applies.

15. A system of claim 12, wherein displaying the computed tax liability further comprises displaying one or more of a tax rate for the withdrawal and an indication that indicates an early withdrawal charge has been assessed to the withdrawal.

16. A system of claim 11, wherein computing a tax liability for the pre-tax portion requested for withdrawal further comprises:
receiving, from the user, an estimated taxable income for a taxable year;
comparing the estimated taxable income to stored tax rates for the taxable year.

17. A system of claim 11, wherein a traditional account may be one of a 401k, an individual retirement account, a savings account, a checking account, or a certificate of deposit and wherein the financial account comprises at least two subaccounts that comprise traditional accounts.

18. A system of claim 17, wherein the at least two traditional accounts are different types of accounts.

19. A system of claim 11,
wherein the financial account comprises a least two subaccounts where each subaccount has a pre-tax balance, and
wherein displaying a first portion of the financial account that comprises one or more pre-tax tracked deposits along with an indication that the first portion comprises a pre-tax balance for the financial account further comprises displaying a sum of a pre-tax balance for the at least two accounts.

20. One or more non-transitory computer readable media having stored thereon instructions that, when executed by an apparatus, cause the apparatus to:
receive a first deposit for a financial account, wherein the first deposit comprises a pre-tax deposit;
track the first deposit as a pre-tax deposit;
receive a second deposit for the financial account, wherein the second deposit comprises a post-tax deposit;
track the second deposit as a post-tax deposit
display, to a user, a first portion of the financial account that comprises one or more pre-tax tracked deposits along with an indication that the first portion comprises a pre-tax balance for the financial account and a second portion of the financial account that comprises one or more post-tax tracked deposits along with an indication that the second portion comprises a post-tax balance of the financial account;
receive a request to withdraw funds from a pre-tax portion of the financial account;
compute a tax liability for the pre-tax portion requested for withdrawal;
display, to the user, the computed tax liability for the withdrawal.
